(19) United States
(12) Patent Application Publication
(10) Pub. No.: US 2023/0294499 A1
(43) Pub. Date: Sep. 21, 2023

(54) LOCKING MECHANISM, BATTERY BRACKET, ELECTRIC VEHICLE, AND METHOD FOR LOCKING AND UNLOCKING BATTERY PACK

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Chunhua Huang, Shanghai (CN)

(21) Appl. No.: 18/020,445

(22) PCT Filed: Aug. 9, 2021
(86) PCT No.: PCT/CN2021/111418

§ 371 Date: Feb. 9, 2023

(30) Foreign Application Priority Data
Aug. 10, 2020 (CN) 202010794648.6

(51) Int. Cl. B60K 1/04; F16M 13/02

(52) U.S. Cl. CPC B60K 1/04; F16M 13/02; B60K 2001/0455

(57) ABSTRACT

Disclosed are a locking mechanism, a battery bracket, an electric vehicle, and a method for locking and unlocking a battery pack. The locking mechanism comprises a lock base and a lock tongue; the lock tongue is rotatably mounted on the lock base around a rotary shaft; the lock base is provided with an accommodating cavity; the lock tongue is rotated so that a lock shaft located within the accommodating cavity is in a locked state and an unlocked state. When the lock shaft moves in the accommodating cavity, the lock tongue may be driven to rotate downward, preventing the lock tongue from rotating upward and causing the lock shaft to convert into the unlocked state, and improving the reliability of fixing a battery pack.

The present application claims the priority of Chinese patent application 2020107946486 filed on Aug. 10, 2020. The present application cites the above-mentioned Chinese patent application in its entirety.

### TECHNICAL FIELD

The present invention relates to a locking mechanism, a battery bracket, an electric vehicle, and a method for locking and unlocking a battery pack.

### BACKGROUND

The existing methods of mounting battery packs for electric vehicles are generally mounting a fixed type battery pack and a replaceable type battery pack, wherein the fixed type battery pack is generally fixed on a vehicle, and the vehicle is directly used as a charging object during charging. In addition, the replaceable battery pack is generally fixed to a bracket of a vehicle by means of a movable mounting, the battery pack can be removed for separate replacement or charging operation, and mounted on the vehicle after the replaced battery pack has been charged.

In the prior art, the method for replacing a battery pack comprises manual and automatic methods, etc., no matter which method is used, when a battery is mounted on a bracket of a vehicle, the bracket needs to lock the battery on the bracket, due to the large volume and heavy weight of the battery, a multi-point locking method is usually used to achieve the method. Regarding a locking mechanism, how to quickly and conveniently lock or unlock the battery on the bracket of the vehicle is a core of research by a person skilled in the art.

### CONTENT OF THE PRESENT INVENTION

The technical problem to be solved in the present invention is for overcoming the defect of the weak connection between the battery pack and the battery bracket in the prior art, and providing a locking mechanism, a battery bracket, an electric vehicle, and a method for locking and unlocking a battery pack.

The present invention solves the above-mentioned technical problem through the following technical solutions:

a locking mechanism comprising a lock base and a lock tongue rotatably mounted on the lock base around a rotary shaft, the lock base being provided with an accommodating cavity for locking and fixing a lock shaft of a battery pack, the lock tongue being rotated so that the lock shaft located within the accommodating cavity is in a locked state and an unlocked state, which is characterized in that when the lock shaft is in the locked state, a shaft center of the rotary shaft of the lock tongue is higher than the shaft center of the lock shaft.

In the present case, the lock shaft can be placed in the accommodating cavity, and when the lock shaft is in the locked state, the lock shaft is locked in the accommodating cavity by the lock tongue, so that the battery pack is fixed with the lock base. When the lock tongue rotates upward, the lock shaft is converted into an unlocked state and can be removed from the accommodating cavity, thereby effectively reducing the complication and complexity of the process for mounting and dismounting the battery pack. In addition, in the locked state, even if the electric vehicle is violently shaken during driving to cause the lock shaft to move relative to the lock base, thereby causing the lock shaft to exert an acting force on the lock tongue, since a shaft center of the rotary shaft of the lock tongue is higher than the shaft center of the lock shaft, the acting force will cause a downward rotation tendency of the lock tongue, i.e. a rotation tendency in the locking direction, thereby improving the locking stability of the lock shaft in the lock base, preventing the lock shaft from converting to the unlocked state due to the upward rotation of the lock tongue, and even in a turbulence state, the locking mechanism is not easy to automatically unlock, improving the reliability of battery pack fixing.

Preferably, one end of the accommodating cavity is a locking position of the lock shaft, and the other end is a connection position of a rotary shaft of the lock tongue, and the lock tongue comprises a fixed end rotatably connected to the rotary shaft, a contact end extending toward the locking position of the lock shaft and adapted to abut the lock shaft, and a rotation end extending toward the outside of the lock base and adapted to rotate about the rotary shaft under an external force.

In this case, the fixed end of the lock tongue is rotatably connected to one end of the accommodating cavity, and the contact end of the lock tongue can then bear the lock shaft against the other end of the accommodating cavity, so that the lock shaft is restrained in the locking position. An external force may be applied to the rotation end to rotate the lock tongue about the rotational shaft center to convert the lock shaft between the locked state and the unlocked state.

Preferably, when the lock shaft is in the locked state, the lock shaft exerts a first acting force on the lock tongue, and the rotary shaft exerts a second acting force on the lock tongue, and the first acting force is opposite to the second acting force.

In this case, the first acting force and the second acting force which are opposite to each other are jointly applied to the lock tongue, so that the lock tongue is fixed, reducing the possibility of rotation of the lock tongue due to turbulence of the vehicle, preventing the locking mechanism from being undesirably automatically unlocked, and ensuring the reliability of fixing the lock shaft.

Preferably, the rotation end abuts downwardly against the top of the lock base when the lock shaft is in the locked state.

In this case, when the lock shaft is moved toward the outside of the accommodating cavity in the locked state, the lock tongue can be made to have a downward rotation tendency, and since the rotation end downward abuts against the top of the lock base, the lock tongue does not rotate but remains stationary, the lock shaft cannot escape from the accommodating cavity, and the battery pack can be firmly connected to the vehicle frame.

Preferably, the lock shaft generates a first acting force on the lock tongue, the first acting force forms a first moment with respect to the rotary shaft, and the lock base generates a third acting force on the rotation end, the third acting force forms a second moment with respect to the rotary shaft, and the first moment is opposite to the second moment.

In this case, the first moment causes the lock tongue to tend to rotate downwards, so that even if the lock shaft moves in the direction of the lock tongue, the lock tongue does not move upwards due to the acting force of the lock shaft to make the lock shaft convert from the locked state to the unlocked state. At the same time, the second moment enables the lock tongue not to rotate downwards excessively, ensuring the stability of the lock tongue when the lock shaft is in a locked state, and preventing the lock tongue from rotating downwards due to the action of the lock shaft. Therefore, in the locked state, the more the lock shaft moves toward the lock tongue, the higher the locking stability of the lock tongue with respect to the lock shaft, and the less likely the lock tongue will rotate and the lock shaft will be in the unlocked state. Thus, the interaction of the first moment and the second moment improves the locking stability of the lock tongue to the lock shaft.

Preferably, the lock tongue comprises a contact end that abuts against the lock shaft when the lock shaft is in the locked state, and the position on the lock shaft that contacts the contact end includes an outer wall of the lock shaft below the shaft center of the lock shaft.

In this case, the contact end is at least in contact with the outer wall of the lock shaft in a lowered position, which enables the direction of the first acting force to be directed below the shaft center of the rotary shaft, so that the first moment tends to drive the lock tongue to move downwards instead of upwards. Moreover, the contact end of such configuration prevents the lock shaft from sliding out of the accommodating cavity below the lock tongue.

Preferably, the lock tongue includes a contact end, and the contact between the contact end and the outer circumferential surface of the lock shaft is a surface contact.

In this case, the contact end has a cambered surface that is fitted to the outer circumferential surface of the lock shaft and partially coated on the lock shaft so that the contact end is firmly fitted to the lock shaft to improve the stability and reliability of the locked state.

Preferably, the contact end is provided with a tangent angle extending towards the shaft center of the lock shaft, and the tangent angle contacts an outer wall of the lock shaft below the shaft center of the lock shaft when the lock shaft is in the locked state.

In this case, the tangent angle contacts the lower surface of the lock shaft to prevent the lock shaft from coming out of contact with the accommodating cavity below the lock tongue. Further, the lock shaft can exert a first acting force on the lock tongue at least partly through a tangent angle, so that the direction of the first acting force can be directed below the rotary shaft, which enables a first moment generated by the first acting force to drive the lock tongue downwards without rotating the lock tongue upwards, resulting in unlocking of the locking mechanism.

Preferably, the shaft center line of the lock shaft and the shaft center line of the rotary shaft are provided to be located on the same reference plane, and an angle exists between the movement direction of the lock shaft in the accommodating cavity and the reference plane.

In this case, in a common case (such as the lock tongue being in surface contact with the lock shaft), the movement direction of the lock shaft in the accommodating cavity is consistent or basically consistent with the direction of the first acting force, and since there is an included angle between the movement direction of the lock shaft and the reference plane, it is possible to avoid the first acting force being directed to the shaft center of the rotary shaft, otherwise the first acting force cannot generate the first moment.

Preferably, the locking mechanism comprises an elastic member that acts on the lock shaft such that the lock shaft in the locked state is press-fixed to the locked position in the accommodating cavity by the elastic member and the lock tongue.

In this case, the lock shaft is fixed in the locking position under the combined action of the lock tongue and the elastic member to ensure a stable connection of the battery pack. The elastic member and the lock tongue may be located on different sides of the lock shaft, and the elastic member allows the lock shaft to abut the lock tongue, i.e., the first acting force is provided by the elastic member. When unlocking is required, the lock shaft can be driven to move in the direction of the elastic member, and then the lock tongue is rotated so that the lock shaft is converted to the unlocked state. The elastic member may be provided within the accommodating cavity.

Preferably, the locking mechanism comprises at least two sets of the lock bases and lock tongues.

In this case, by providing a plurality of sets of lock bases and lock tongues, the support strength of the locking mechanism for the battery pack and the locking safety are improved.

Preferably, the locking mechanism comprises a connecting rod to which a rotation end of each of the lock tongues is connected to achieve simultaneous locking and unlocking of a plurality of the lock tongues.

In this case, using an external force to drive the connecting rod or any lock tongue, all the lock tongues can be driven to rotate synchronously to realize the synchronous locking and unlocking of multiple lock tongues, and therefore the control of locking and unlocking is relatively convenient, which is beneficial to the rapid locking and unlocking of the battery pack.

Preferably, the lock base has an opening for the lock shaft to enter the accommodating cavity, and the opening has a guide portion.

In this case, the lock shaft can enter and exit the accommodating cavity through the opening, and the guide portion of the opening enables the lock shaft to enter the accommodating cavity smoothly, thereby reducing the positioning requirements for the lock shaft when the lock shaft enters the accommodating cavity.

Preferably, the opening is provided downward, and the guide portion constitutes a flared mouth that flares downward.

In this case, when the lock shaft needs to enter and exit the accommodating cavity, the lock tongue rotates upwards, and since the opening of the accommodating cavity faces downwards, the lock shaft does not interfere with the lock tongue when entering and exiting the opening. The guiding structure of the flared mouth is simple and easy to implement.

Preferably, the lock tongue comprises a fixedly connected lock tongue body and a lock tongue extension located outside the lock base, and the lock tongue body is able to prevent the lock shaft from leaving the cavity from the opening when the lock tongue is in the locked state;

the locking mechanism further comprises a return member provided to the lock base and acting on the lock tongue, and the return member is elastically deformable for rotating the lock tongue in a locking direction to return from the unlocked state to the locked state.

In this case, the return member is provided to facilitate the return of the lock tongue from the unlocked state to the locked state, so that the mounting and locking of the battery pack are both convenient, and when the lock tongue is in the locked state, under the action of the return member, the lock tongue abuts against the lock shaft, and the lock tongue does not easily change to the unlocked state, so that the locking is more reliable; providing a lock tongue extension located outside the lock base, and rotating and unlocking the lock tongue body can be achieved by acting on the lock tongue extension; the locking mechanism may provide a secondary locking or locking protection function for the battery pack to prevent the battery pack from falling out when the existing device fails to lock, improving safety performance.

A battery bracket comprising a locking mechanism as described above.

In this case, the battery bracket can lock and unlock the battery pack conveniently and quickly to effectively reducing the complication and complexity of the process for mounting and dismounting the battery pack. Further, the battery bracket can stably lock the lock shaft in the locked state, and when an external force is applied to the lock shaft, the battery bracket has a certain anti-interference capability, and the locking mechanism does not automatically unlock to ensure the reliability of battery pack fixing.

An electric vehicle comprising the battery bracket as described above.

In this case, the electric vehicle can achieve the locking and unlocking of the battery pack in a relatively simple structure, and the electric vehicle has a high locking stability for the battery pack, and the battery pack cannot easily fall off from the electric vehicle under external interference.

A method for locking a battery pack using a locking mechanism as described above, which comprises the following steps of:

placing the lock shaft of the battery pack in the accommodating cavity; and

rotating the lock tongue so that the lock shaft is in the locked state.

In this case, the lock shaft is restrained in the accommodating cavity by merely placing the lock shaft in the accommodating cavity and then rotating the lock tongue, so that the battery pack is fixed to the electric vehicle, the locking of the battery pack can be conveniently achieved, and since the locking mechanism does not automatically unlock, the reliability of the fixing of the battery pack is ensured.

A method for unlocking a battery pack using a locking mechanism as described above, which comprises the following steps of:

rotating the lock tongue so that the lock shaft in the unlocked state; and

removing the lock shaft of the battery pack from the accommodating cavity.

In this case, the lock shaft can be removed from the accommodating cavity by merely rotating the lock tongue, so that the battery pack can be removed from the heavy-duty electric vehicle for a subsequent power exchange operation, and the replacement of the battery pack can be conveniently achieved.

The positive effect of the present invention is that

according to the locking mechanism, the battery bracket, the electric vehicle and the method for locking and unlocking the battery pack of the present invention, the lock shaft is placed in an accommodating cavity, when the lock shaft is in a locked state, the lock shaft is locked in the accommodating cavity by the lock tongue, so that the battery pack is fixed with the lock base, and the lock tongue rotates upwards, then the lock shaft is converted to an unlocked state and can be removed from the accommodating cavity, and the locking and unlocking operations only require rotating the lock tongue, which is very convenient, thereby effectively reducing the complication and complexity of the process for mounting and dismounting the battery pack. Further, in the locked state, as the shaft center of the rotary shaft of the lock tongue in the locked state is higher than the shaft center of the lock shaft, thus when the lock shaft moves in the accommodating cavity, the lock tongue may be driven to rotate downward, preventing the lock tongue from rotating upward and causing the lock shaft to convert into the unlocked state, and improving the reliability of fixing a battery pack.

### BRIEF DESCRIPTION OF THE DRAWINGS

FIG. 1 is a schematic view of a locking mechanism according to Embodiment 1 of the present invention.

FIG. 2 is a schematic diagram showing the connection relationship between the locking mechanism and the lock shaft according to Embodiment 1 of the present invention, when the lock shaft is in a locked state.

FIG. 3 is a schematic view showing the connection relationship between the locking mechanism and the lock shaft according to Embodiment 1 of the present invention, when the lock shaft moves in the direction of the elastic member and comes out of contact with the lock tongue.

FIG. 4 is a schematic diagram showing a connection relationship between a locking mechanism and a lock shaft according to Embodiment 1 of the present invention, when the lock shaft is in an unlocked state.

FIGS. 5a to 5c are acting force analysis diagrams of the locking mechanism according to Embodiment 1 of the present invention.

FIGS. 6a to 6c are schematic structural views (II) of a locking mechanism according to Embodiment 1 of the present invention.

FIG. 7 is a schematic flow chart of a method for locking a battery pack according to Embodiment 1 of the present invention.

FIG. 8 is a flow chart showing a method for unlocking a battery pack according to Embodiment 1 of the present invention.

FIG. 9 is a schematic cross-sectional view of a lock base according to Embodiment 2 of the present invention.

FIG. 10 is a schematic perspective view of a lock tongue according to Embodiment 2 of the present invention.

FIGS. 11a to 11e show a lock shaft mounting process according to Embodiment 2 of the present invention.

### DESCRIPTION OF REFERENCE NUMERALS

lock base 1; accommodating cavity 11; opening 12; guide portion 121; first limiting surface 13; lock tongue 2; fixed end 21; contact end 22; tangent angle 221; rotation end 23; pressing surface 231; lock tongue body 24; lock tongue extension 25; second limiting surface 251; lock shaft 3; rotary shaft 4; elastic member 5; connecting rod 6; return member 7; locking mechanism 100; first acting force F1; second acting force F2; third acting force F3; height difference d

### DETAILED DESCRIPTION OF THE PREFERRED EMBODIMENT

The invention is further illustrated by the following examples, which are not intended to limit the invention thereto.

In the description of the present invention, it is to be understood that the terms “upper”, “lower”, “front”, “rear”, “left”, “right”, “vertical”, “horizontal”, “top”, “bottom”, “inner”, “outer”, “clockwise”, “counterclockwise”, and the like indicate orientations or positional relationships based on those shown in the drawings, are merely for convenience in describing the present invention and to simplify the description, and do not indicate or imply that the referenced devices or elements must have a particular orientation, be constructed and operated in a particular orientation, and thus are not to be construed as limiting the present invention.

### Embodiment 1

An embodiment of the present invention provides an electric vehicle having a battery bracket for mounting a battery pack, on which a locking mechanism 100 capable of locking and unlocking the battery pack mounted on the battery bracket is provided.

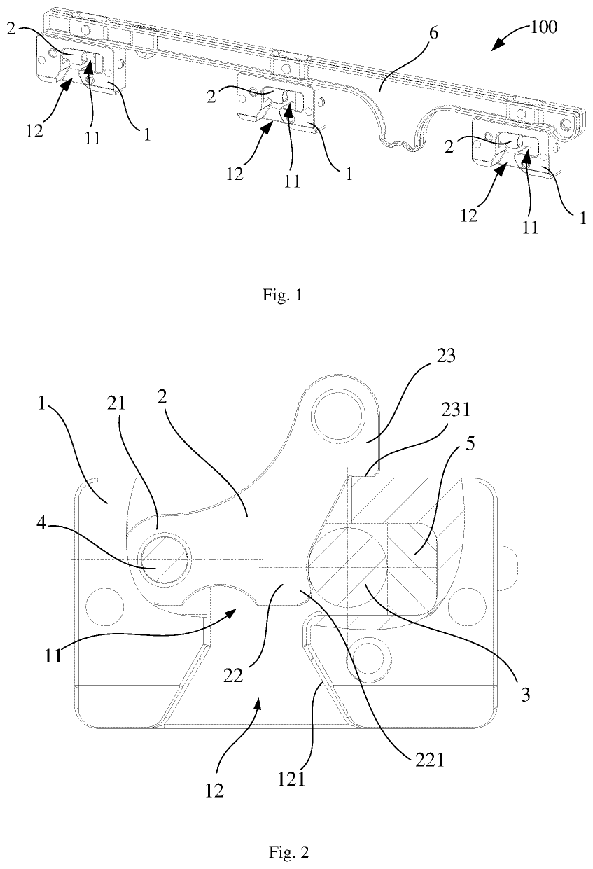

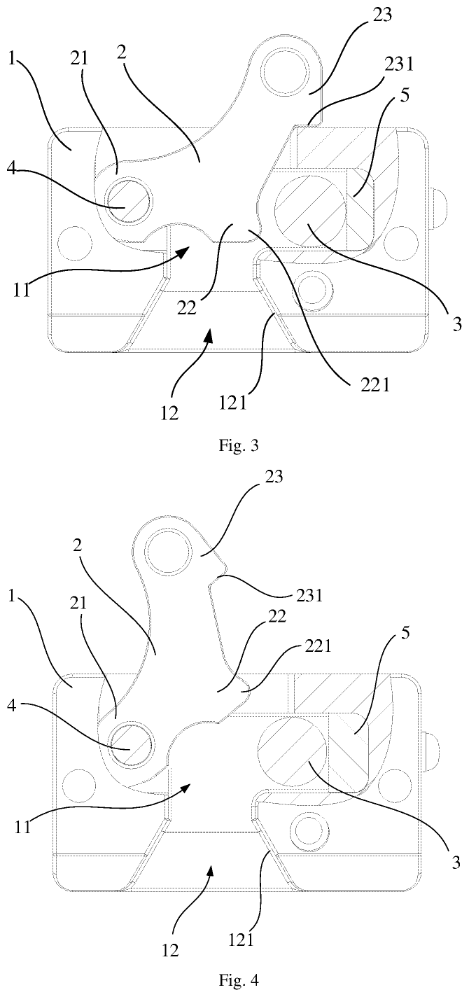

As shown in FIGS. 1-4, the locking mechanism 100 comprises a lock base 1 and a lock tongue 2, wherein the lock tongue 2 is rotatably mounted to the lock base 1 about a rotary shaft 4, the lock base 1 has an accommodating cavity 11 for locking and fixing the lock shaft of the battery pack, the accommodating cavity 11 has an opening 12 through which the lock shaft 3 of the battery pack can enter and exit the accommodating cavity 11, and the lock shaft 3 located in the accommodating cavity 11 can be in a locked state or an unlocked state by rotating the lock tongue 2. Specifically, referring to FIGS. 2 to 4, when the lock tongue 2 rotates downward to the position shown in FIG. 2, the lock shaft 3 located in the accommodating cavity 11 is in a locked state, and when the lock tongue 2 rotates upward to the position shown in FIG. 4, the lock shaft 3 is converted to an unlocked state and can be removed from the accommodating cavity 11, so that the locking mechanism 100 can be easily converted between the locked state and the unlocked state, thereby effectively reducing the complication and complexity of the process for mounting and dismounting the battery pack.

As shown in FIG. 2, when the lock shaft 3 is in the locked state, the lock shaft 3 is locked in the accommodating cavity 11 by the lock tongue 2 so that the battery pack is mounted on the battery bracket. At the same time, the shaft center of the rotary shaft 4 of the lock tongue 2 is higher than the shaft center of the lock shaft 3; when the lock shaft 3 moves towards the opening 12 of the accommodating cavity 11 under the action of an external force, the lock shaft 3 can drive the lock tongue 2 to have a downward rotation tendency, preventing the lock shaft 3 from moving to the opening 12, so that the lock shaft 3 is in a stable locked state in the accommodating cavity 11, preventing the lock shaft 3 from converting to an unlocked state due to the upward rotation of the lock tongue 2; and even in a state where the electric vehicle runs in a rough state, the locking mechanism 100 will not automatically unlock due to its own movement, improving the reliability of battery pack fixing.

One end of the accommodating cavity 11 is a locking position of the lock shaft 3, and the other end is a connection position of the rotary shaft 4 of the lock tongue 2. The lock tongue 2 includes a fixed end 21 rotatably connected to the rotary shaft 4, a contact end 22 extending from the fixed end 21 toward the locking position of the lock shaft 3, and adapted to abut the lock shaft 3 to restrict the movement of the lock shaft 3, and a rotation end 23 extending from the fixed end 21 toward the outside of the locking base 1 above the accommodating cavity 11, and adapted to rotate about the rotary shaft 4 under external force. The fixed end 21 of the lock tongue 2 is rotatably connected to one end of the accommodating cavity 11, the rotary shaft 4 is mounted in the lock base, and the contact end 22 of the lock tongue 2 can abut the lock shaft 3 against the other end of the accommodating cavity 11, so that the lock shaft 3 is restrained in the locking position. An external force may be applied to the rotation end 23 to rotate the lock tongue 2 about the rotational shaft center 4 to convert the lock shaft 3 between the locked state and the unlocked state. The rotation end 23 of the lock tongue 2 has a pressing surface 231 which can be fitted to the top wall of the lock base 1 when the lock shaft 3 is in the locked state.

When the lock shaft 3 is in the locked state, the rotation end 23 abuts downward against the top wall of the lock base 1. When the lock shaft 3 in the locked state moves relative to the lock base toward the opening 12 of the accommodating cavity 11 during the running of the electric vehicle due to the sway of the vehicle, the lock shaft 3 exerts an acting force on the lock tongue, and since the shaft center of the rotary shaft 4 of the lock tongue 2 is higher than the shaft center of the lock shaft 3, the acting force can cause the lock tongue 2 to have a downward rotation tendency, and at the same time, since the rotation end 23 abuts downward against the top of the lock base 1 and prevents the lock tongue 2 from rotating downward, the lock tongue 2 does not rotate, but is maintained in a stable locked state, the lock shaft 3 cannot come out of contact with the accommodating cavity 11, and the battery pack can be securely attached to the vehicle frame. In the vehicle turbulence state, the lock tongue itself is easy to rotate about the rotary shaft, and the acting force exerted on the lock tongue by the lock shaft prevents the lock shaft from converting to the unlocked state due to the rotation of the lock tongue itself.

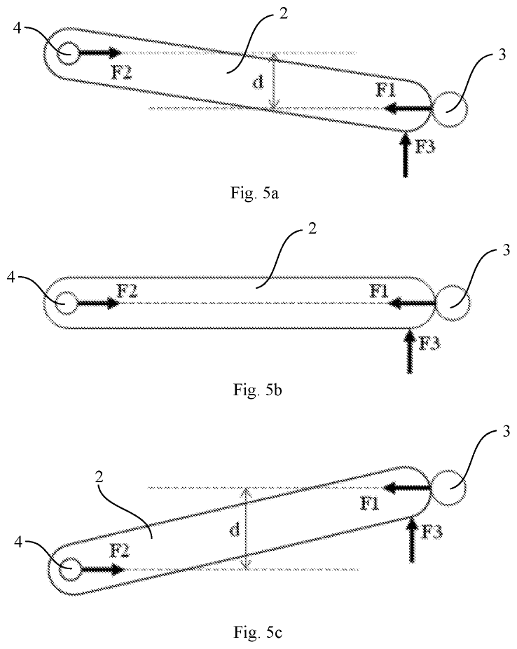

Further, as shown in FIG. 5a, since the shaft center line of the rotary shaft 4 in this embodiment is higher than the shaft center line of the lock shaft 3, there is a height difference d therebetween, and when the lock shaft 3 is in the locked state, the lock shaft 3 applies a first acting force F1 to the lock tongue 2, the rotary shaft 4 applies a second acting force F2 to the lock tongue 2, and the first acting force F1 and the second acting force F2 are opposite in direction. A first acting force F1 and a second acting force F2 which are opposite are applied together to the lock tongue 2, so that the lock tongue 2 is maintained in a stable locked state, and therefore the lock tongue 2 is not easily rotated even if the vehicle is in turbulence, thereby preventing an undesired automatic unlocking of the locking mechanism 100 and ensuring the reliability of fixing the lock shaft 3.

At the same time, the first acting force F1 forms a first moment with respect to the rotary shaft 4, and the lock base (not shown in the figure) generates a third acting force F3 to the rotary end of the lock tongue 2, and the third acting force F3 forms a second moment with respect to the rotary shaft 4, and the first moment is opposite to the second moment.

The first moment causes the lock tongue 2 to tend to rotate downwards, so that even if the lock shaft 3 moves towards the outside of the accommodating cavity, the lock tongue 2 does not move upwards, causing the lock shaft 3 to convert from the locked state to the unlocked state. At the same time, the second moment is such that the lock tongue 2 does not rotate too far downwards, which would cause the lock shaft 3 to come out of contact with the accommodating cavity. Therefore, in the locked state, the more the lock shaft 3 moves toward the outside of the accommodating cavity, the less easily the lock shaft 3 moves away from the accommodating cavity.

In contrast, as shown in FIG. 5b, if the shaft center line of the rotary shaft 4 is made to be flush with the shaft center line of the lock shaft 3, although the first acting force F1 and the second acting force F2 can also be generated in the opposite direction, since the first acting force F1 does not generate a first moment, the third acting force F3 must be zero; otherwise, the second moment generated by the third acting force F3 will make the lock tongue 2 unable to be balanced, that is to say, the lock tongue will not abut against the lock base, which will reduce the stability of the lock tongue in the locked state.

As another comparison, as shown in FIG. 5c, if the shaft center line of the rotary shaft 4 is made lower than the shaft center line of the lock shaft 3, the first acting force F1 and the third acting force F3 are in the same direction with respect to the moment generated by the rotation seat 4 and cannot be balanced, so that the lock tongue cannot be smoothly locked.

It can be seen from the above-mentioned acting force analysis that since the shaft center line of the rotary shaft 4 in this embodiment is higher than the shaft center line of the lock shaft 3, when in a locked state, the lock tongue 2 remains stable under the combined action of multiple acting forces and multiple moments, reducing the possibility of automatic unlocking due to the automatic turnover of the lock tongue 2, the locking mechanism 100 has a considerable resistance to external interference, and the battery pack can be relatively reliably locked on the battery bracket of the electric vehicle.

The contact end 22 of the lock tongue 2 is in contact with the lock shaft 3 when the lock shaft 3 is in a locked state, and the position of the lock shaft 3 in contact with the contact end 22 comprises an outer wall of the lock shaft 3 below the shaft center of the lock shaft 3. That is to say, the contact end 22 has a stop structure protruding downward, and the stop structure of the contact end 22 at least contacts the position where the outer wall of the lock shaft 3 is located downward, which enables the direction of the first acting force to be directed below the shaft center of the rotary shaft 4, and ensures that the first moment can drive the lock tongue 2 to move downwards instead of upwards. Further, the above-mentioned downwardly protruding limiting structure can prevent the lock shaft 3 from sliding out of the accommodating cavity 11 below the lock tongue 2, ensuring that the lock shaft 3 is securely locked in the accommodating cavity 11.

The contact between the contact end 22 and the outer circumferential surface of the lock shaft 3 is a surface contact. In this embodiment, the contact end 22 has a cambered surface that fits to the outer circumferential surface of the lock shaft 3 and is partially coated on the lock shaft 3, so that the contact end 22 firmly fits to the lock shaft 3, improving the stability and reliability of the locked state.

The contact end 22 is provided with a tangent angle 221 protruding toward the shaft center of the lock shaft 3, and when the lock shaft 3 is in a locked state, the tangent angle 221 contacts an outer wall of the lock shaft 3 below the shaft center of the lock shaft 3. The tangent angle 221 contacts the lower surface of the lock shaft 3 and prevents the lock shaft 3 from coming out of contact with the accommodating cavity 11 below the lock tongue 2. Further, the lock shaft 3 can exert a first acting force on the lock tongue 2 at least partly through the tangent angle 221, so that the direction of the first acting force can be directed below the shaft center of the rotary shaft 4, which enables a first moment generated by the first acting force to drive the lock tongue 2 downwards without rotating the lock tongue 2 upwards, resulting in unlocking of the locking mechanism 100.

The shaft center line of the lock shaft 3 and the shaft center line of the rotary shaft 4 are provided to be located in the same reference plane, and there is an included angle between the movement direction of the lock shaft 3 in the accommodating cavity 11 and the reference plane. In a common case (e.g. the lock tongue 2 is in surface contact with the lock shaft 3), the direction of movement of the lock shaft 3 in the accommodating cavity 11 is consistent or basically consistent with the direction of the first acting force, and since there is an angle between the direction of movement of the lock shaft 3 and the reference plane, it is possible to avoid that the first acting force is directed to the shaft center of the rotary shaft 4, otherwise the first acting force cannot generate the first moment.

The locking mechanism 100 further comprises an elastic member 5 that acts on the lock shaft 3 such that the lock shaft 3 in the locked state is press-fixed in the locked position in the accommodating cavity 11 by the elastic member 5 and the lock tongue 2.

The lock shaft 3 is fixed in the locking position under the combined action of the lock tongue 2 and the elastic member 5 to ensure a stable connection of the battery pack. The elastic member 5 and the lock tongue 2 may be located on different sides of the lock shaft 3, the elastic member 5 allows the lock shaft 3 to abut against the lock tongue 2, i.e., the first acting force is provided by the elastic member 5. When unlocking is required, the lock shaft 3 can be first driven to move in the direction of the elastic member 5 so that the lock shaft 3 comes out of contact with the lock tongue 2, the contact end 22 of the lock tongue 2 is not blocked by the lock shaft 3 when rotating upwards, and then the lock tongue 2 rotates upward so that the lock shaft 3 is converted to the unlocked state. In this embodiment, the elastic member 5 may be provided in the accommodating cavity 11, and one end of the elastic member 5 is connected to the lock base and the other end thereof abuts the lock shaft. In certain other preferred embodiments, the elastic member 5 may also be provided outside the accommodating cavity 11. The elastic member 5 is preferably a silica gel pad or a rubber pad, and may be an elastic member or the like.

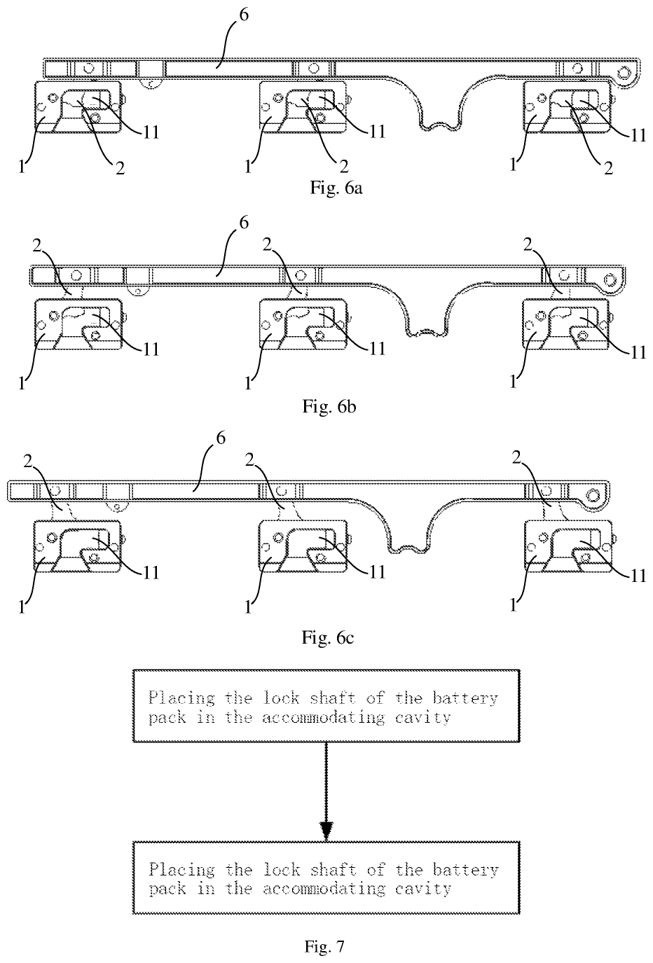

As shown in FIGS. 6a to 6c, the locking mechanism 100 includes at least two sets of the lock bases 1 and the lock tongues 2. By providing a plurality of sets of the lock bases 1 and the lock tongues 2, the locking mechanism 100 has a strong fixing ability to the battery pack.

The locking mechanism 100 comprises a connecting rod 6, and a rotary end 23 of each lock tongue 2 is connected to the connecting rod 6, and when the connecting rod 6 is driven to move, or a certain lock tongue 2 is driven to move, a plurality of lock tongues 2 can rotate synchronously, thereby achieving synchronous locking and unlocking of a plurality of lock shafts 3 by the plurality of lock tongues 2. In this embodiment, the rotation end 23 is pivotally connected (e.g. by a pin) to the connecting rod 6.

By using an external force to drive the connecting rod 6 or any lock tongue 2, all the lock tongues 2 can be driven to rotate synchronously, and a plurality of lock tongues 2 can be synchronously converted from a locked state (FIG. 6a) to an unlocked state (FIG. 6c) via an intermediate state (FIG. 6b), and vice versa to realize the synchronous locking and unlocking of a plurality of lock shafts 3, and therefore the control of locking and unlocking is relatively convenient, facilitating the rapid locking and unlocking of the battery pack.

The opening 12 of the lock base 1 has a guide portion 121, in particular, the opening 12 is provided downward, and the guide portion 121 constitutes a flared mouth that opens downward. The lock shaft 3 can enter and exit the accommodating cavity 11 through the opening 12, and the guide portion 121 of the opening 12 enables the lock shaft 3 to enter the accommodating cavity 11 smoothly, thereby reducing the positioning requirements for the lock shaft 3 when the lock shaft 3 enters the accommodating cavity 11. When the lock shaft 3 needs to enter and exit the accommodating cavity 11, the lock tongue 2 rotates upwards, and since the opening 12 of the accommodating cavity 11 faces downwards, the lock shaft 3 does not interfere with the lock tongue 2 when entering and exiting the opening 12. The guiding structure of the flared mouth is simple and easy to implement.

As shown in FIG. 7, this embodiment also provides a method for locking a battery pack using the above-described locking mechanism 100, which comprises the following steps of:

placing the lock shaft 3 of the battery pack in the accommodating cavity 11; and

rotating the lock tongue 2 so that the lock shaft 3 is in a locked state.

With this locking method, it is only necessary to place the lock shaft 3 into the accommodating cavity 11, and then rotate the lock tongue 2, so that the lock shaft 3 is restrained in the accommodating cavity 11, so that the battery pack is fixed to the electric vehicle, and the locking of the battery pack can be conveniently achieved, and since the locking mechanism 100 does not automatically unlock, the reliability of the battery pack fixing is ensured.

The locking method specifically comprises: the lock shaft 3 of the battery pack is moved upwards to enter the accommodating cavity 11 via the opening 12; the lock shaft 3 drives the lock tongue 2 to rotate upwards, and then opens the channel between the opening 12 and the accommodating cavity 11; after the lock shaft 3 moves upwards to a pre-set position, the lock shaft of the battery pack is moved in a horizontal direction away from the lock tongue 2 to a locking position; the lock tongue 2 falls down, and a channel between the opening 12 and the accommodating cavity 11 is closed; the lock shaft 3 is locked in the accommodating cavity 11; and the lock shaft 3 is pressed and fixed at the locking position by the lock tongue and the elastic member, so that the lock tongue 2 is in a locked state.

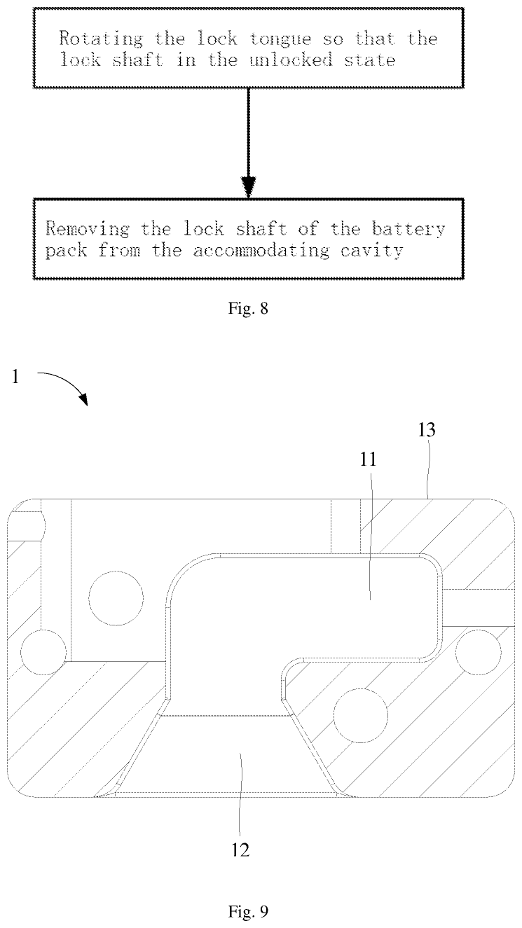

As shown in FIG. 8, this embodiment also provides a method for unlocking a battery pack using the locking mechanism 100 as described above, which comprises the following steps of:

rotating the lock tongue 2 so that the lock shaft 3 is in an unlocked state; and

removing the lock shaft 3 of the battery pack from the accommodating cavity 11.

With this unlocking method, the lock shaft 3 can be removed from the accommodating cavity 11 by merely rotating the lock tongue 2, so that the battery pack can be removed from the heavy the heavy-duty electric vehicle for a subsequent power exchange operation, and the replacement of the battery pack can be conveniently achieved.

The unlocking method specifically comprises: the battery pack lock shaft is moved away from the lock tongue 2 to an unlocking pre-tightening position, the lock tongue 2 rotates upwards, a channel between the opening 12 and the accommodating cavity 11 is opened, so that the lock shaft 3 is in an unlocked state, the battery pack lock shaft is moved towards the opening 12, and the lock shaft 3 is removed from the locking base 1.

### Embodiment 2

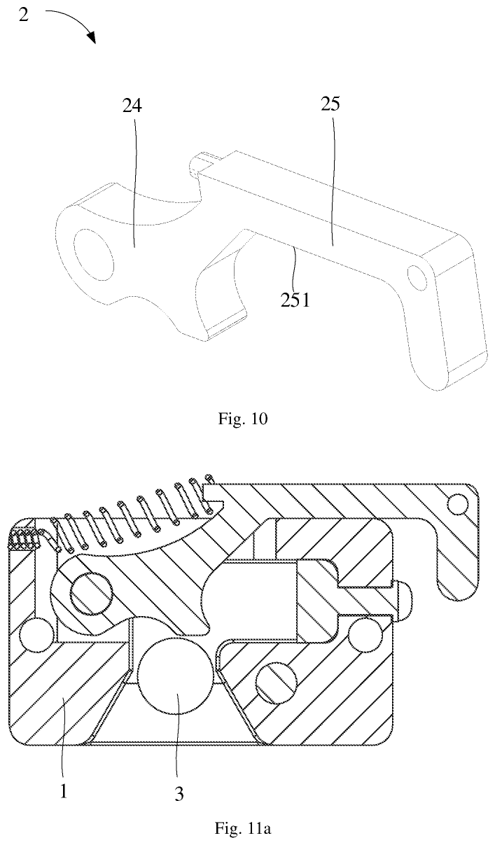

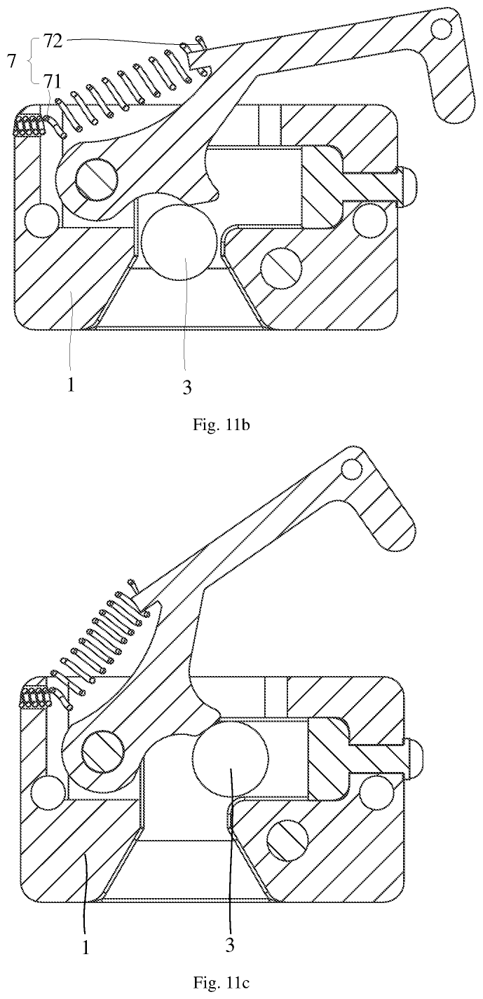

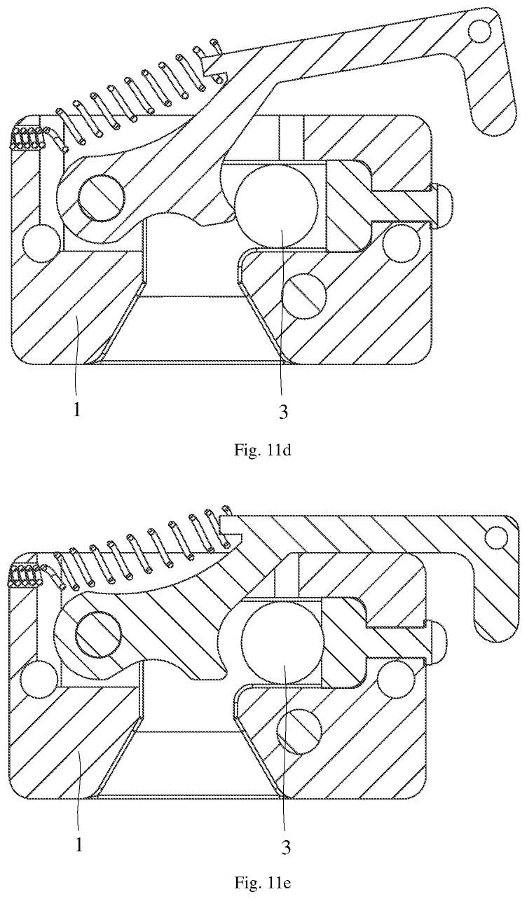

As shown in FIG. 9, FIG. 10, and FIG. 11a to FIG. 11e, this embodiment discloses another locking mechanism 100, which is similar to Embodiment 1 except for at least: the locking mechanism 100 further comprises a return member 7, the lock tongue 2 comprises a lock tongue body 24 and a lock tongue extension 25, the return member 7 is provided on the lock base 1 and acts on the lock tongue 2, the return member 7 can be elastically deformed, and the return member 7 is used for rotating the lock tongue 2 in a locking direction to return from an unlocked state to a locked state. Preferably, the return member 7 may be an elastic member, a torsion spring, a spring plate, or the like. The lock tongue extension 25 is located outside the lock base 1, and when the lock tongue 2 is in the locked state, the lock tongue body 24 can prevent the lock shaft 3 from leaving the accommodating cavity 11 from the opening 12. The lock tongue extension 25 located outside the lock base 1 is provided, and the lock tongue body 24 can be rotated by acting on the lock tongue extension 25 to facilitate unlocking. The return member 7 has a first spring portion 71 and a second spring portion 72. The first spring portion 71 is connected to the lock base 1, and the second spring portion 72 is connected to the lock tongue 2.

As shown in FIG. 9, the lock base 1 has a first limiting surface 13, and the first limiting surface 13 is an outer wall surface of the lock base 1. Specifically, it is an upper outer wall surface of the lock base 1. As shown in FIG. 6, the lock tongue extension 25 has a second limiting surface 251. The second limiting surface 251 is specifically a lower outer surface of the lock tongue 2. As shown in FIG. 11a or 11e, when the lock tongue 2 is in the locked state, the first limiting surface 13 abuts against the second limiting surface 251 to prevent the lock tongue 2 from continuing to rotate in the locking direction. In FIGS. 11a-11e, the locking direction is clockwise. When the lock tongue 2 rotates in the locking direction until the first limiting surface 13 contacts the second limiting surface 251, the lock tongue 2 does not continue to rotate and stops in the locked state.

When the lock shaft 3 is in a locked state, the shaft center of the rotary shaft of the lock tongue 2 is higher than the shaft center of the lock shaft 3, and on the basis of the acting force analysis in embodiment 1, the return member 7 is added to apply a downward rotation moment to the lock tongue 2, so that the lock shaft 3 is in an unlocked state due to the lock tongue 2 turning over itself is avoided;

The locking process of the locking mechanism 100 of this embodiment is as follows (i.e. the mounting process of FIGS. 11a to 11e, and the lock tongue 2 changing from the locked state to the unlocked state to the locked state): from FIG. 11a to FIG. 11c, the lock shaft 3 moves upwards under the action of an external force, enters the accommodating cavity 11 via the opening 12, and the lock shaft 3 acts on the lock tongue body 24 so that the lock tongue 2 rotates in a counterclockwise direction; the lock tongue 2 acts on the second spring portion 72 of the return member 7, so that the elastic acting force of the return member 7 changes; FIGS. 11c to 11e, after the lock tongue 2 is rotated to a certain angle, a channel is formed in the accommodating cavity 11 for the lock shaft 3 to pass through, and the lock shaft 3 can move from left to right; until the lock shaft 3 is no longer in contact with the lock tongue body 24, the lock tongue 2 is rotated clockwise by the return member 7 to return to the locked state.

The unlocking process of the locking mechanism 100 of this embodiment is as follows: an acting force is applied upward to the lock tongue extension 25 so that the lock tongue 2 rotates in a counterclockwise direction; the lock tongue 2 acts on the second spring portion 72 of the return member 7, so that the elastic acting force of the return member 7 changes; after the lock tongue 2 is rotated to a certain angle, a channel through which the lock shaft 3 can pass is formed in the accommodating cavity 11; the lock shaft 3 is movable from right to left and then downwards through the opening 12 away from the locking mechanism 100.

While embodiments of the present invention have been described above, it will be understood by a person skilled in the art that this has been done by way of example only, and the scope of the invention is to be determined by the claims that follow. Various changes or modifications to these embodiments may be made by a person skilled in the art without departing from the principle and spirit of this invention, and these changes and modifications are within the scope of this invention.

1. A locking mechanism comprising a lock base and a lock tongue rotatably mounted on the lock base around a rotary shaft, the lock base being provided with an accommodating cavity for locking and fixing a lock shaft of a battery pack, the lock tongue being rotated so that the lock shaft located within the accommodating cavity is in a locked state and an unlocked state, characterized in that when the lock shaft is in the locked state, a shaft center of the rotary shaft of the lock tongue is higher than a shaft center of the lock shaft;
the lock shaft generates a first acting force on the lock tongue, the first acting force forms a first moment with respect to the rotary shaft, and the lock base generates a third acting force on the lock tongue, the third acting force forms a second moment with respect to the rotary shaft, and the first moment is opposite to the second moment.

2. The locking mechanism according to claim 1, characterized in that one end of the accommodating cavity is a locking position of the lock shaft, and the other end is a connection position of the rotary shaft of the lock tongue, and the lock tongue comprises a fixed end rotatably connected to the rotary shaft, a contact end extending toward the locking position of the lock shaft and adapted to abut the lock shaft, and a rotation end extending toward the outside of the lock base and adapted to rotate about the rotary shaft under an external force.

3. The locking mechanism according to claim 2, characterized in that when the lock shaft is in the locked state, the lock shaft exerts a first acting force on the lock tongue, and the rotary shaft exerts a second acting force on the lock tongue, and the first acting force is opposite to the second acting force.

4. A locking mechanism according to claim 2, characterized in that the rotation end abuts downwardly against the top of the lock base when the lock shaft is in the locked state.

5. (canceled)

6. The locking mechanism according to claim 1, characterized in that the lock tongue comprises a contact end that abuts against the lock shaft when the lock shaft is in the locked state, and a position on the lock shaft that contacts the contact end includes an outer wall of the lock shaft below the shaft center of the lock shaft.

7. The locking mechanism according to claim 1, characterized in that the lock tongue comprises a contact end, and the contact between the contact end and an outer circumferential surface of the lock shaft is a surface contact.

8. The locking mechanism according to claim 7, characterized in that the contact end is provided with a tangent angle extending towards the shaft center of the lock shaft, and the tangent angle contacts an outer wall of the lock shaft below the shaft center of the lock shaft when the lock shaft is in the locked state.

9. The locking mechanism according to claim 2, characterized in that a shaft center line of the lock shaft and a shaft center line of the rotary shaft are provided to be located on a same reference plane, and an angle exists between a movement direction of the lock shaft in the accommodating cavity and the reference plane.

10. The locking mechanism according to claim 2, characterized in that the locking mechanism comprises an elastic member that acts on the lock shaft such that the lock shaft in the locked state is press-fixed to the locked position in the accommodating cavity by the elastic member and the lock tongue.

11. A locking mechanism according to claim 1, characterized in that the locking mechanism comprises at least two sets of the lock bases and the lock tongues.

12. The locking mechanism according to claim 11, characterized in that the locking mechanism comprises a connecting rod to which a rotation end of each of the lock tongues is connected to achieve simultaneous locking and unlocking of a plurality of the lock tongues.

13. The locking mechanism according to claim 1, characterized in that the lock base has an opening for the lock shaft to enter the accommodating cavity, and the opening has a guide portion.

14. The locking mechanism according to claim 13, characterized in that the opening is provided downward, and the guide portion constitutes a flared mouth that flares downward.

15. The locking mechanism according to claim 1, characterized in that the lock tongue comprises a fixedly connected lock tongue body and a lock tongue extension, the lock tongue extension located outside the lock base, and the lock tongue body can prevent the lock shaft from leaving the accommodating cavity from the opening of the accommodating cavity when the lock tongue is in the locked state;
the locking mechanism further comprises a return member provided to the lock base and acting on the lock tongue, and the return member is elastically deformable for rotating the lock tongue in a locking direction to return from the unlocked state to the locked state.

16. A battery bracket, characterized by comprising the locking mechanism according to claim 1.

17. An electric vehicle, characterized by comprising the battery bracket according to claim 16.

18. A method for locking a battery pack, characterized in that the method for locking the battery pack uses the locking mechanism according to claim 1, and the method for locking the battery pack comprises the following steps of:
placing the lock shaft of the battery pack in the accommodating cavity; and
rotating the lock tongue so that the lock shaft is in the locked state.

19. A method for unlocking a battery pack, characterized in that the method for unlocking the battery pack uses the locking mechanism according to claim 1, and the method for unlocking the battery pack comprises the following steps of:
rotating the lock tongue so that the lock shaft is in the unlocked state; and
removing the lock shaft of the battery pack from the accommodating cavity.
